(19) United States
(12) Patent Application Publication
(10) Pub. No.: US 2023/0205230 A1
(43) Pub. Date: Jun. 29, 2023

(54) UNMANNED VEHICLE CONTROL SYSTEM, UNMANNED VEHICLE, AND UNMANNED VEHICLE CONTROL METHOD

(71) Applicant: Komatsu Ltd., Tokyo (JP)

(72) Inventors: Kenta Osagawa, Tokyo (JP); Yasuyuki Yamada, Tokyo (JP)

(73) Assignee: Komatsu Ltd., Tokyo (JP)

(21) Appl. No.: 17/914,898

(22) PCT Filed: May 10, 2021
(86) PCT No.: PCT/JP2021/017762

§ 371 Date: Sep. 27, 2022

(30) Foreign Application Priority Data
Jun. 19, 2020 (JP) 2020-106428

(51) Int. Cl. G05D 1/10; G08G 5/04; G08G 5/00

(52) U.S. Cl. CPC G05D 1/101; G08G 5/045; G08G 5/0086

(57) ABSTRACT

An unmanned vehicle control system 1 includes: a traveling condition data generation unit 322 that generates traveling condition data including a travel course of an unmanned vehicle and a traveling speed of the unmanned vehicle; and a travel control unit 124 that controls the unmanned vehicle on a basis of the traveling condition data generated by the traveling condition data generation unit 322, in which the traveling condition data generation unit 322 changes a speed limit of the traveling speed of the unmanned vehicle on the basis of information indicating a safety level when the unmanned vehicle travels on a side of a manned vehicle.

### FIELD

The present disclosure relates to an unmanned vehicle control system, an unmanned vehicle, and an unmanned vehicle control method.

BACKGROUND

There are cases where unmanned vehicles that travel in an unmanned manner along a travel course are used in a wide-area work site such as a mine.

### CITATION LIST

### Patent Literature

Patent Literature 1: WO 98/045765 A

### SUMMARY

### Technical Problem

At a work site, a manned vehicle that travels by operation of an operator may be used together with an unmanned vehicle. In a case where an unmanned vehicle travels on a side of a manned vehicle, it is desirable to limit the traveling speed of the unmanned vehicle for safety. However, when the unmanned vehicle is unnecessarily decelerated, there is a possibility that productivity at the work site is lowered.

An object of an aspect of the present disclosure is to secure safety of a work site where an unmanned vehicle operates and to suppress a decrease in productivity.

### Solution to Problem

According to an aspect of the present invention, an unmanned vehicle control system comprises: a traveling condition data generation unit that generates traveling condition data including a travel course of an unmanned vehicle and a traveling speed of the unmanned vehicle; and a travel control unit that controls the unmanned vehicle on a basis of the traveling condition data generated by the traveling condition data generation unit, wherein the traveling condition data generation unit changes a speed limit of the traveling speed of the unmanned vehicle on a basis of information indicating a safety level when the unmanned vehicle travels on a side of a manned vehicle.

### Advantageous Effects of Invention

According to an aspect of the present disclosure, it is possible to ensure safety of a work site where an unmanned vehicle operates and to suppress a decrease in productivity.

### BRIEF DESCRIPTION OF DRAWINGS

FIG. 1 is a diagram schematically illustrating an example of a control system and an unmanned vehicle according to an embodiment.

FIG. 2 is a diagram schematically illustrating an unmanned vehicle and a travel path according to the embodiment.

FIG. 3 is a functional block diagram illustrating an unmanned vehicle control system of according to the embodiment.

FIG. 4 is a flowchart illustrating an unmanned vehicle control method according to the embodiment.

FIG. 5 is a schematic diagram illustrating an example of a speed limit of the unmanned vehicle.

FIG. 6 is a schematic diagram illustrating another example of the speed limit of the unmanned vehicle.

FIG. 7 is a block diagram illustrating an example of a computer system according to the embodiment.

### DESCRIPTION OF EMBODIMENTS

Hereinafter, embodiments of the present disclosure will be described with reference to the drawings; however, the present disclosure is not limited thereto. Components of the embodiments described below can be combined as appropriate. Moreover, some of the components may not be used.

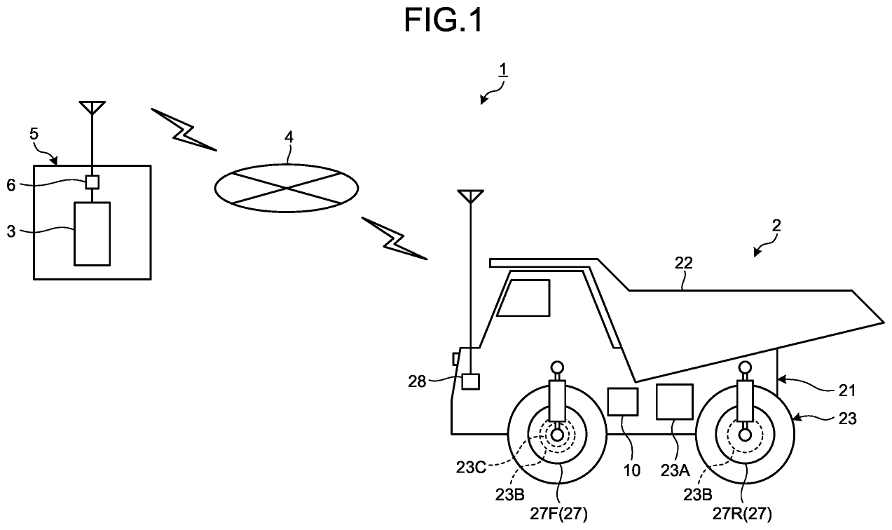

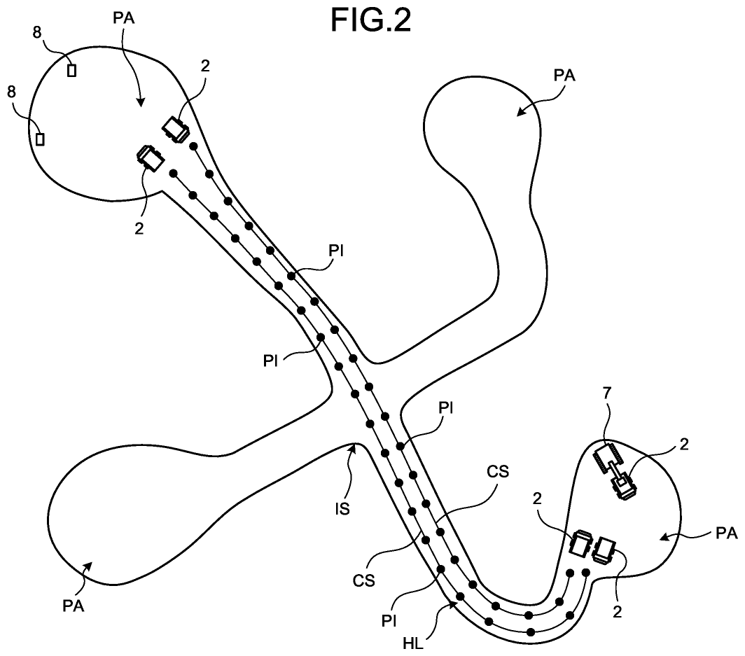

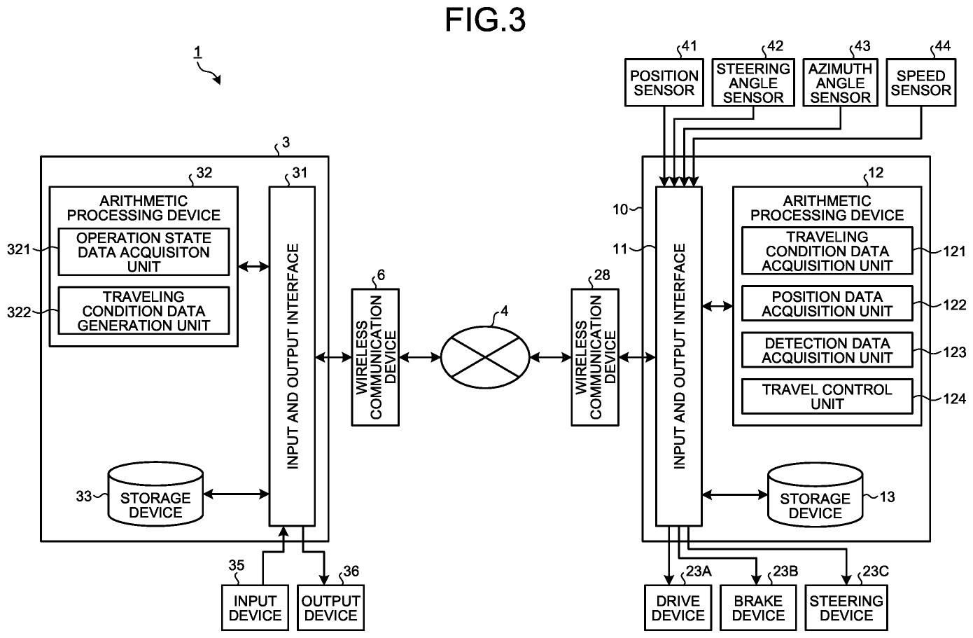

FIG. 1 is a diagram schematically illustrating an example of a control system 1 and an unmanned vehicle 2 according to the present embodiment. FIG. 2 is a diagram schematically illustrating the unmanned vehicles 2 and a travel path HL according to the embodiment. FIG. 3 is a functional block diagram illustrating the control system 1 of the unmanned vehicle 2 according to the embodiment. In the present embodiment, manned vehicles are used together with the unmanned vehicle 2 at a work site. The unmanned vehicle 2 travels on an outdoor unpaved road. In other words, the work site where the unmanned vehicle 2 operates includes an outdoor unpaved road such as a mine. The unmanned vehicle 2 refers to a work vehicle that travels in an unmanned manner in accordance with a control command without depending on a driving operation by a driver. A manned vehicle refers to a work vehicle that travels by operation of an operator.

The work site is, for example, a mine. The mine refers to a place or a business site where minerals are mined. The load carried by the unmanned vehicle 2 is, for example, ore or earth and sand excavated in a mine. As illustrated in FIG. 2, the unmanned vehicles 2 and manned vehicles travel on at least a part of the travel path HL leading to a plurality of work areas PA in the mine. The work area PA includes at least one of a loading station or a soil discharging site. The work area PA may include at least one of a fuel station or a parking lot. The travel path HL includes an intersection IS. The loading place refers to an area in which loading work for loading a load on an unmanned vehicle 2 is performed. In the loading station, a loader 7 such as a hydraulic shovel operates. The soil discharging site refers to an area where discharging work for discharging a load from an unmanned vehicle 2 is performed. For example, crushers 8 are installed in the soil discharging site.

The unmanned vehicles 2 are, for example, dump trucks that travel at the work site and transport a load. The manned vehicles are, for example, dump trucks, the loader, the crushers, or the like that travel at the work site and transport a load.

The control system 1 includes a management device 3 and a communication system 4. The management device 3 includes a computer system and is installed in a control facility 5 at a work site. There is an administrator in the control facility 5. The communication system 4 performs communication between the management device 3 and the unmanned vehicle 2. A wireless communication device 6 is connected to the management device 3. The communication system 4 includes the wireless communication device 6. The management device 3 and the unmanned vehicle 2 wirelessly communicate with each other via the communication system 4. Although not illustrated, the management device 3 and a manned vehicle wirelessly communicate with each other via the communication system 4. The unmanned vehicle 2 and the manned vehicle output operation state data of each of the vehicles to the management device 3. The unmanned vehicle 2 travels on the travel path HL at the work site on the basis of traveling condition data transmitted from the management device 3. The unmanned vehicle 2 travels along a travel course CS set in the travel path HL and the work area PA on the basis of a control signal from the management device 3.

### Unmanned Vehicle

The unmanned vehicle 2 includes a vehicle body 21, a dump body 22 supported by the vehicle body 21, a traveling device 23 supporting the vehicle body 21, a wireless communication device 28, a position sensor 41, a steering angle sensor 42, an azimuth angle sensor 43, a speed sensor 44, and a control device 10. The control device 10 will be described later.

The vehicle body 21 includes a vehicle body frame and supports the dump body 22. The vehicle body 21 also includes a hydraulic pump (not illustrated) and a plurality of hydraulic cylinders (not illustrated) that operate with hydraulic oil discharged from the hydraulic pump.

The dump body 22 is a member on which a load is loaded. The dump body 22 ascends and descends by the operation of a hoist cylinder which is a hydraulic cylinder. The dump body 22 is adjusted to at least one of a loading attitude and a dump attitude by the operation of the hoist cylinder. The loading attitude is an attitude in which a load can be loaded and is an attitude in which the dump body 22 has descended. The dump attitude is an attitude in which the load is discharged and is an attitude in which the dump body 22 has ascended.

The traveling device 23 includes wheels 27 and travels on the travel path HL. The wheels 27 include front wheels 27F and rear wheels 27R. A tire is mounted on a wheel 27. The traveling device 23 includes a drive device 23A, brake devices 23B, and steering devices 23C.

The drive device 23A generates a driving force for accelerating the unmanned vehicle 2. The drive device 23A includes an internal combustion engine such as a diesel engine. Note that the drive device 23A may include an electric motor. The driving force generated by the drive device 23A is transmitted to the rear wheels 27R, and the rear wheels 27R rotate. When the rear wheels 27R rotate, the unmanned vehicle 2 is self-propelled.

The brake devices 23B generate a braking force for decelerating or stopping the unmanned vehicle 2.

The steering devices 23C can adjust the traveling direction of the unmanned vehicle 2. The traveling direction of the unmanned vehicle 2 includes the orientation of the front portion of the vehicle body 21. The steering devices 23C adjust the traveling direction of the unmanned vehicle 2 through steering of the front wheels 27F. A steering device 23C includes a steering cylinder which is a hydraulic cylinder. The front wheels 27F are steered by the power generated by the steering cylinder.

The wireless communication device 28 wirelessly communicates with the wireless communication device 6 connected to the management device 3. The communication system 4 includes the wireless communication device 28.

The position sensor 41 detects the position of the unmanned vehicle 2 traveling on the travel path HL. Detection data of the position sensor 41 includes absolute position data indicating the absolute position of the unmanned vehicle 2. The absolute position of the unmanned vehicle 2 is detected using a global navigation satellite system (GNSS). The global navigation satellite system includes the global positioning system (GPS). The position sensor 41 includes a GNSS receiver. The global navigation satellite system detects the absolute position of the unmanned vehicle 2 defined by coordinate data of longitude, latitude, and altitude. The global navigation satellite system detects the absolute position of the unmanned vehicle 2 defined in the global coordinate system. The global coordinate system refers to a coordinate system fixed to the earth.

The steering angle sensor 42 detects a steering angle of the unmanned vehicle 2 by the steering devices 23C. The steering angle sensor 42 includes, for example, a rotary encoder included in the steering devices 23C. The detection data of the steering angle sensor 42 includes steering angle data indicating a steering angle of the unmanned vehicle 2.

The azimuth angle sensor 43 detects an azimuth angle of the unmanned vehicle 2. The azimuth angle of the unmanned vehicle 2 includes a yaw angle of the unmanned vehicle 2. The yaw angle refers to an inclination angle of the unmanned vehicle 2 about a rotation axis extending in the vertical direction of the unmanned vehicle 2. Detection data of the azimuth angle sensor 43 includes azimuth angle data indicating an azimuth angle of the unmanned vehicle 2. The azimuth of the unmanned vehicle 2 is the traveling direction of the unmanned vehicle 2. The azimuth angle sensor 43 includes, for example, a gyro sensor.

The speed sensor 44 detects the traveling speed of the unmanned vehicle 2. Detection data of the speed sensor 44 includes traveling speed data indicating the traveling speed of the traveling device 23.

Data detected by the position sensor 41, the steering angle sensor 42, the azimuth angle sensor 43, and the speed sensor 44 of the unmanned vehicle 2 is output to the management device 3 as operation state data of the unmanned vehicle 2.

### Manned Vehicle

In the work site of the mine, not only the unmanned vehicles 2 but also the manned vehicles travel. The manned vehicles travel in the work site in order to manage or monitor the work site. The manned vehicles output the operation state data to the management device 3 similarly to the unmanned vehicles 2.

### Control System

As illustrated in FIG. 3, the control system 1 includes the management device 3 and the control device 10. The control system 1 appropriately controls the speed limit of the unmanned vehicles 2 at the work site where the manned vehicles are used together with the unmanned vehicles 2. The control device 10 can communicate with the management device 3 via the communication system 4.

### Management Device

The management device 3 sets a traveling condition of the unmanned vehicle 2 on the travel path HL. The unmanned vehicle 2 travels on the travel path HL on the basis of traveling condition data defining the traveling condition transmitted from the management device 3.

The management device 3 includes a computer system. The management device 3 includes an input and output interface 31, an arithmetic processing device 32 including a processor such as a central processing unit (CPU), and a storage device 33 including a memory such as a read only memory (ROM) or a random access memory (RAM) and a storage.

The input and output interface 31 is connected to each of an input device 35, an output device 36, and the wireless communication device 6. Each of the input device 35, the output device 36, and the wireless communication device 6 is installed in the control facility 5. The input and output interface 31 transmits the traveling condition data to the unmanned vehicle 2 via the communication system 4. The input and output interface 31 receives the operation state data from the unmanned vehicle 2 and the manned vehicle via the communication system 4.

The arithmetic processing device 32 includes an operation state data acquisition unit 321 and a traveling condition data generation unit 322.

The operation state data acquisition unit 321 acquires operation state data indicating the operation states of the unmanned vehicles 2 and the manned vehicles at the work site, which is one piece of information indicating the safety level. The information indicating the safety level may include information indicating the attribute of a manned vehicle. The attribute of a manned vehicle includes, for example, at least one of the size of the manned vehicle or the quality of the field of view. The information indicating the safety level may include information indicating an attribute of the operator. The attribute of the operator includes, for example, at least one of the skill or the proficiency level of the operator of the manned vehicle. The proficiency level can be calculated from, for example, the number of years of experience or driving time of the operator. The information indicating the safety level includes information indicating a place such as an intersection or a work area located ahead in the traveling direction of the unmanned vehicle 2. The information indicating the safety level includes, for example, information indicating an obstacle ahead in the traveling direction of the unmanned vehicle 2. The information indicating the safety level may include information indicating the environment of the work site. The information indicating the environment of the work site includes, for example, at least one of the period of time or the weather at the work site. The information indicating the safety level includes information indicating the presence or absence of another unmanned vehicle 2 around the unmanned vehicle 2.

The operation state data acquisition unit 321 acquires the operation state data indicating the operation state of the unmanned vehicle 2 transmitted from the control device 10 via the input and output interface 31.

The operation state data of the unmanned vehicle 2 refers to data indicating the operation state of the unmanned vehicle 2. The operation state data of the unmanned vehicle 2 includes detection data of the sensors mounted on the unmanned vehicle 2. The operation state data of the unmanned vehicle 2 includes vehicle data such as the type, the size, or others of the unmanned vehicle 2. In addition, the operation state data acquisition unit 321 acquires operation state data of the manned vehicle via the input and output interface 31. The operation state data of the manned vehicle refers to data indicating the operation state of the manned vehicle. The operation state data of the manned vehicle includes detection data of sensors mounted on the manned vehicle.

The traveling condition data generation unit 322 generates traveling condition data that defines the traveling conditions of the unmanned vehicle 2. More specifically, the traveling condition data generation unit 322 generates traveling condition data including a travel course of the unmanned vehicle 2 and the traveling speed of the unmanned vehicle at the work site. The traveling condition data generation unit 322 communicates with each of the input device 35, the output device 36, and the wireless communication device 6 via the input and output interface 31.

The traveling condition is determined, for example, by an administrator present in the control facility 5. The administrator operates the input device 35 connected to the management device 3. The traveling condition data is generated on the basis of input data generated by operation of the input device 35.

The traveling condition data includes a target position, a target traveling speed (traveling speed), a target azimuth, and the travel course CS of the unmanned vehicle 2.

As illustrated in FIG. 2, the traveling condition data includes a plurality of target points PI set at intervals on the travel path HL. An interval between target points PI is set to, for example, a range between 1 [m] and 5 [m]. A target point PI defines a target position of the unmanned vehicle 2. The target traveling speed and the target azimuth are set at each of the plurality of target points PI. The travel course CS is defined by a line connecting the plurality of target points PI. That is, the traveling condition data defining the traveling condition of the unmanned vehicle 2 includes the plurality of target points PI indicating target positions of the unmanned vehicle 2 and the target traveling speed and the target azimuth of the unmanned vehicle 2 set at each of the plurality of target points PI.

A target position of the unmanned vehicle 2 refers to a target position of the unmanned vehicle 2 defined in the global coordinate system. That is, a target position refers to a target position in coordinate data defined by longitude, latitude, and altitude. A target position includes a target position in longitude (x coordinate) and a target position in latitude (y coordinate). Note that a target position of the unmanned vehicle 2 may be defined in a local coordinate system of the unmanned vehicle 2.

The target traveling speed of the unmanned vehicle 2 refers to a target traveling speed of the unmanned vehicle 2 when traveling (passing) through the target point PI. For example, in a case where a target traveling speed at a target point PI is set, the drive device 23A or the brake devices 23B of the unmanned vehicle 2 is controlled so that the actual traveling speed of the unmanned vehicle 2 when traveling through the target point PI is the target traveling speed.

The target azimuth of the unmanned vehicle 2 refers to a target azimuth of the unmanned vehicle 2 when traveling (passing) through the target point PI. Meanwhile, a target azimuth refers to an azimuth angle of the unmanned vehicle 2 with respect to a reference azimuth (for example, north). In other words, a target azimuth is a target azimuth of the front portion of the vehicle body 21 and indicates a target traveling direction of the unmanned vehicle 2. For example, in a case where a target azimuth at a target point PI is set, the steering devices 23C of the unmanned vehicle 2 are controlled so that the actual azimuth of the unmanned vehicle 2 when traveling through the target point PI is the target azimuth.

The traveling condition data generation unit 322 determines whether or not the unmanned vehicle 2 passes through the vicinity of a manned vehicle. The traveling condition data generation unit 322 determines whether or not the unmanned vehicle 2 passes through the vicinity of a manned vehicle on the basis of the position data included in the operation state data of the unmanned vehicle 2 and the position data included in the operation state data of the manned vehicle.

In a case where the unmanned vehicle 2 passes through the vicinity of a manned vehicle, the traveling condition data generation unit 322 changes the speed limit of the traveling speed of the unmanned vehicle 2 on the basis of information indicating the safety level when the unmanned vehicle 2 travels on a side of the manned vehicle. The traveling condition data includes a speed limit indicating a speed limit that is the maximum speed of the target speed. The speed limit is set for every work site. The speed limit is set to be lower than the normal speed limit in a case where the unmanned vehicle 2 travels on a side in the vicinity of a manned vehicle, which is smaller than the unmanned vehicle 2, and satisfies a predetermined condition under which the safety level decreases. The vicinity of a manned vehicle means, for example, within a radius of about 100 [m] of the manned vehicle. The predetermined condition is at least one of a condition related to the manned vehicle, a condition related to a place, a condition related to the environment, and a condition related to another unmanned vehicle 2. The predetermined condition is determined on the basis of the information indicating the safety level.

Hereinafter, changing the speed limit of the traveling speed of the unmanned vehicle 2 when the unmanned vehicle 2 passes in the vicinity of a manned vehicle will be described in detail. The traveling condition data generation unit 322 changes the speed limit of the unmanned vehicle 2 on the basis of the attribute of the manned vehicle. More specifically, in a case where the manned vehicle is a small vehicle, the traveling condition data generation unit 322 lowers the speed limit of the unmanned vehicle 2. For example, in a case where the unmanned vehicle 2 travels on a side in the vicinity of the manned vehicle, which is smaller than the unmanned vehicle 2, the traveling condition data generation unit 322 generates a traveling condition in which the speed limit of the unmanned vehicle 2 is reduced. This is because there is a possibility that the safety of the small manned vehicle is impaired in a case where the unmanned vehicle 2 and the small manned vehicle come into contact with each other. Whether or not the manned vehicle is smaller than the unmanned vehicle 2 can be determined on the basis of the vehicle data of the unmanned vehicle 2 and the manned vehicle included in the operation state data. Alternatively, regardless of the size or the type of the unmanned vehicle 2, in a case where the manned vehicle is small, the speed limit of the unmanned vehicle 2 may be reduced.

In a case where the manned vehicle provides a poor field of view, the traveling condition data generation unit 322 lowers the speed limit of the unmanned vehicle 2.

For example, in a case where the unmanned vehicle 2 travels on a side in the vicinity of the manned vehicle, which provides a poor field of view, the traveling condition data generation unit 322 generates a traveling condition in which the speed limit of the unmanned vehicle 2 is reduced.

This is because in a case where the manned vehicle provides a poor field of view, the operator of the manned vehicle may have difficulty in visually recognizing the unmanned vehicle 2. It is possible to determine whether or not the manned vehicle is a type of vehicle with a poor field of view on the basis of the vehicle data of the manned vehicle included in the operation state data.

The traveling condition data generation unit 322 changes the speed limit of the unmanned vehicle 2 on the basis of the attribute of the manned vehicle. More specifically, in a case where the skill or the proficiency level of the operator of the manned vehicle is low, the traveling condition data generation unit 322 lowers the speed limit of the unmanned vehicle 2. For example, in a case where the unmanned vehicle 2 travels on a side in the vicinity of the manned vehicle, of which operator has a low skill or proficiency level, the traveling condition data generation unit 322 generates a traveling condition in which the speed limit of the unmanned vehicle 2 is reduced. This is because, in a case where the skill or the proficiency level of the operator is low, there is a possibility that the recognition of the unmanned vehicle 2 is delayed or that the operation of avoiding an obstacle or the like is delayed. It is possible to determine whether or not the skill or the proficiency level of the operator is low on the basis of operator data stored in the storage device 33.

The traveling condition data generation unit 322 changes the speed limit of the unmanned vehicle 2 on the basis of the difficulty level of estimation of the course of the unmanned vehicle 2. More specifically, in a case where it is difficult to estimate the course of the unmanned vehicle 2, the traveling condition data generation unit 322 lowers the speed limit of the unmanned vehicle 2. More specifically, the traveling condition data generation unit 322 lowers the speed limit of the unmanned vehicle 2 in a case where the current position of the unmanned vehicle 2 is at an intersection or in a work area. For example, in a case of a place where it is difficult to estimate the traveling direction of the unmanned vehicle 2, the traveling condition data generation unit 322 generates a traveling condition in which the speed limit of the unmanned vehicle 2 is reduced. Since the unmanned vehicle 2 does not travel along a bank or the like at an intersection or in a work area, it is difficult for the operator of the small manned vehicle to estimate the course of the unmanned vehicle 2. It is possible to determine whether or not it is a place where it is difficult to estimate the traveling direction of the unmanned vehicle 2 depending on whether or not the absolute position data of the unmanned vehicle 2 included in the operation state data indicates, for example, an intersection or a work area.

Alternatively, in a case where there is an obstacle ahead in the traveling direction of the unmanned vehicle 2, the traveling condition data generation unit 322 lowers the speed limit of the unmanned vehicle 2. For example, in a case where there is an obstacle ahead in the traveling direction of the unmanned vehicle 2, the traveling condition data generation unit 322 generates a traveling condition in which the speed limit of the unmanned vehicle 2 is reduced. This is because there is a possibility that the unmanned vehicle 2 changes the traveling direction in order to avoid the obstacle and because it is difficult for the operator of the small manned vehicle to estimate the course of the unmanned vehicle 2. On the basis of the absolute position data of the unmanned vehicle 2 and the obstacle data stored in the storage device 33, it is possible to determine whether or not there is an obstacle ahead in the traveling direction of the unmanned vehicle 2.

The traveling condition data generation unit 322 changes the speed limit of the unmanned vehicle 2 on the basis of the environment of the work site. More specifically, when the work site is at night or in rainy weather, the traveling condition data generation unit 322 lowers the speed limit of the unmanned vehicle 2. For example, the traveling condition data generation unit 322 generates a traveling condition in which the speed limit of the unmanned vehicle 2 is reduced depending on the period of time. This is because the visibility is worse at night than at daytime. In the nighttime, a traveling condition in which the speed limit of the unmanned vehicle 2 is reduced is generated.

For example, the traveling condition data generation unit 322 generates a traveling condition in which the speed limit of the unmanned vehicle 2 is reduced depending on the weather. This is because there is a higher risk of slipping in rainy weather than in sunny or cloudy weather. In a case where the environmental data stored in the storage device 33 indicates rain, a traveling condition in which the speed limit of the unmanned vehicle 2 is reduced is generated.

In a case where another unmanned vehicle is located around the unmanned vehicle, the traveling condition data generation unit 322 lowers the speed limit of the unmanned vehicle. For example, in a case where another unmanned vehicle 2 is present in the vicinity of the unmanned vehicle 2, the traveling condition data generation unit 322 generates a traveling condition in which the speed limit of the unmanned vehicle 2 is reduced. The vicinity of the unmanned vehicle 2 means, for example, for example, within a radius of about 100 [m] of the unmanned vehicle 2. In other words, it refers to a state in which a plurality of unmanned vehicles 2 is present near the manned vehicle. A traveling condition in which the speed limit of the unmanned vehicle 2 is reduced is generated. This is because the number of objects to which the operator of the small manned vehicle pays attention increases. It is possible to determine whether or not another unmanned vehicle 2 is present in the vicinity of the unmanned vehicle 2 on the basis of the operation state data of the plurality of unmanned vehicles 2.

Further, by combining these conditions, the traveling condition data generation unit 322 may generate a traveling condition in which the speed limit of the unmanned vehicle 2 is reduced. In a case where a plurality of conditions is satisfied, the speed limit may be changed to match the lowest speed limit. In a case where a plurality of conditions is satisfied, the speed limit may be reduced as the number of corresponding conditions increases. For example, in a case where another unmanned vehicle 2 is present in the vicinity of the unmanned vehicle 2, the speed limit may be reduced the lowest. For example, in a case of a place where it is difficult to estimate the traveling direction of the unmanned vehicle 2, the speed limit may be reduced the lowest. For example, in a case where there is an obstacle ahead in the traveling direction of the unmanned vehicle 2, the speed limit may be reduced the lowest.

The storage device 33 stores information indicating the safety level input via the input device 35. The information indicating the safety level includes information indicating at least one of the skill or the proficiency level of the operator of the manned vehicle. The information indicating the safety level includes information indicating an obstacle ahead in the traveling direction of the unmanned vehicle 2. The information indicating the safety level includes information indicating at least one of the period of time or the weather at the work site.

The storage device 33 stores obstacle data indicating an obstacle present on a travel path and its position that has been input via the input device 35. The storage device 33 stores environment data indicating the weather at the work site that has been input via the input device 35. The storage device 33 stores operator data indicating the skill or the proficiency level of the operator of the manned vehicle that has been input via the input device 35. The skill or the proficiency level of the operator may be calculated on the basis of the operation time of the manned vehicle of the operator.

The input device 35 generates input data by being operated by the administrator of the control facility 5. The input data generated by the input device 35 is output to the management device 3. The management device 3 acquires the input data from the input device 35. Examples of the input device 35 include a contact-type input device operated by a hand of the administrator, such as a computer keyboard, a mouse, a touch panel, an operation switch, and an operation button. Note that the input device 35 may be a speech input device operated by speech of the administrator.

The output device 36 provides output data to the administrator of the control facility 5. The output device 36 may be a display device that outputs display data, a printing device that outputs print data, or an audio output device that outputs audio data. Examples of the display device includes a flat panel display such as a liquid crystal display (LCD) or an organic electroluminescence display (OELD).

### Control Device

The control device 10 includes a computer system and is disposed in the vehicle body 21. The control device 10 outputs a control command for controlling traveling of the traveling device 23 of the unmanned vehicle 2. The control command output from the control device 10 includes an acceleration command for operating the drive device 23A, a brake command for operating the brake devices 23B, and a steering command for operating the steering devices 23C. The drive device 23A generates a driving force for accelerating the unmanned vehicle 2 on the basis of the acceleration command output from the control device 10. The brake devices 23B generate a braking force for decelerating or stopping the unmanned vehicle 2 on the basis of the brake command output from the control device 10. The steering devices 23C generate a turning force for changing the direction of the front wheels 27F in order to cause the unmanned vehicle 2 to travel straight or turn on the basis of the steering command output from the control device 10.

The control device 10 includes an input and output interface 11, an arithmetic processing device 12 including a processor such as a CPU, and a storage device 13 including a memory such as a ROM or a RAM and a storage. The control device 10 acquires the traveling condition data transmitted from the management device 3 via the communication system 4.

The input and output interface 11 is connected to each of the position sensor 41, the steering angle sensor 42, the azimuth angle sensor 43, the speed sensor 44, the traveling device 23, and the wireless communication device 28. The input and output interface 11 communicates with each of the position sensor 41, the steering angle sensor 42, the azimuth angle sensor 43, the speed sensor 44, the traveling device 23, and the wireless communication device 28.

The arithmetic processing device 12 includes a traveling condition data acquisition unit 121, a position data acquisition unit 122, a detection data acquisition unit 123, and a travel control unit 124.

The traveling condition data acquisition unit 121 acquires the traveling condition data generated by the traveling condition data generation unit 322 of the management device 3.

The position data acquisition unit 122 acquires position data indicating the position of the unmanned vehicle 2 from the position sensor 41.

The detection data acquisition unit 123 acquires detection data of the azimuth angle sensor 43 that has detected the traveling direction of the unmanned vehicle 2 from the azimuth angle sensor 43. The detection data includes steering angle data detected by the steering angle sensor 42, azimuth angle data detected by the azimuth angle sensor 43, and speed data detected by the speed sensor 44. The detection data acquisition unit 123 acquires steering angle data from the steering angle sensor 42, azimuth angle data from the azimuth angle sensor 43, and speed data from the speed sensor 44.

The travel control unit 124 controls the unmanned vehicle on the basis of the traveling condition data generated by the traveling condition data generation unit 322 of the management device 3. More specifically, the travel control unit 124 outputs a control signal for controlling at least one of the drive device 23A, the brake devices 23B, or the steering devices 23C of the unmanned vehicle 2 on the basis of the travel course CS acquired by the traveling condition data acquisition unit 121. The control device 10 outputs the travel course CS generated by the traveling condition data generation unit 322 from the input and output interface 11 to the travel control unit 124 of the unmanned vehicle 2. The travel course CS generated by the traveling condition data generation unit 322 is transmitted from the input and output interface 11 to the travel control unit 124 of the unmanned vehicle 2.

The travel control unit 124 generates a control signal for controlling the travel of the unmanned vehicle 2 on the basis of the travel course CS. The control signal generated by the travel control unit 124 is output from the travel control unit 124 to the traveling device 23. The control signal output from the travel control unit 124 includes an acceleration signal output to the drive device 23A, a brake control signal output to the brake devices 23B, and a steering control signal output to the steering devices 23C. On the basis of the position data detected by the position sensor 41, the travel control unit 124 controls the drive device 23A, the brake devices 23B, and the steering devices 23C so that a state where a specific part of the unmanned vehicle 2 and the travel course CS coincide with each other during the travel.

The travel control unit 124 controls the traveling of the unmanned vehicle 2 on the basis of the traveling condition data. The travel control unit 124 outputs an acceleration command value corresponding to the traveling speed to the drive device 23A of the traveling device 23. The drive device 23A generates power on the basis of the acceleration command value. In a case where speed condition data includes a speed limit, the travel control unit 124 outputs an acceleration command value or a brake command value so as to decelerate the traveling speed.

### Control Method

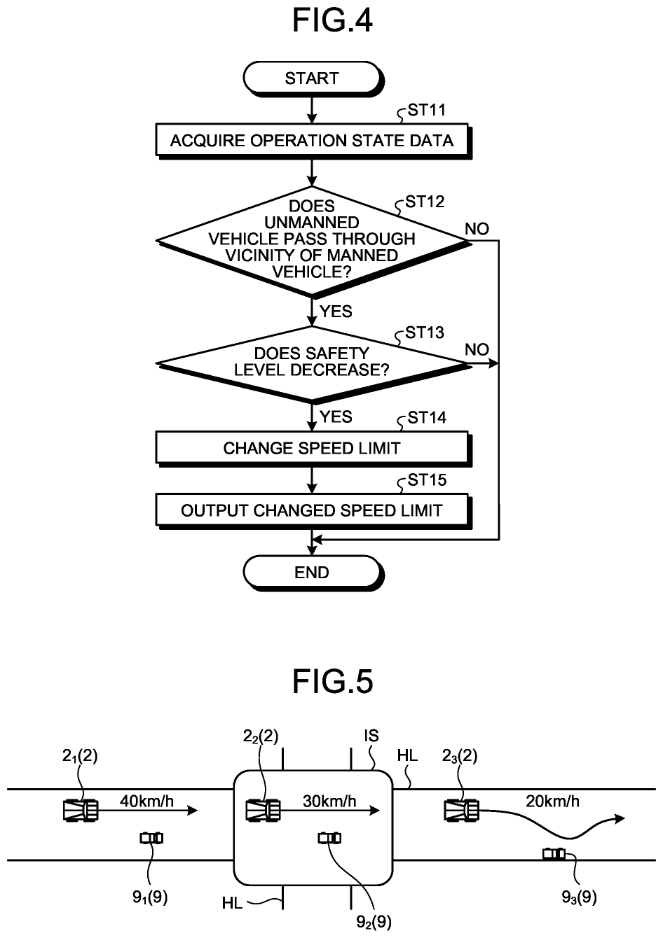

FIG. 4 is a flowchart illustrating a control method of the unmanned vehicle 2 according to the present embodiment. The arithmetic processing device 32 of the management device 3 acquires operation state data from an unmanned vehicle 2 and a manned vehicle at a work site (step ST11). More specifically, by the operation state data acquisition unit 321, the arithmetic processing device 32 acquires operation state data indicating the operation state of the unmanned vehicle 2 transmitted from the control device 10 of the unmanned vehicle 2 via the input and output interface 31. By the operation state data acquisition unit 321, the arithmetic processing device 32 acquires operation state data of the manned vehicle via the input and output interface 31.

The arithmetic processing device 32 determines, by the traveling condition data generation unit 322, whether or not the unmanned vehicle 2 passes through the vicinity of the manned vehicle (step ST12). By the traveling condition data generation unit 322, the arithmetic processing device 32 determines whether or not the unmanned vehicle 2 passes through the vicinity of the manned vehicle on the basis of position data included in the operation state data of the unmanned vehicle 2 and position data included in the operation state data of the manned vehicle. If the arithmetic processing device 32 determines, by the traveling condition data generation unit 322, that the unmanned vehicle 2 pass through the vicinity of the manned vehicle (Yes in step ST12), the processing proceeds to step ST13. If the arithmetic processing device 32 determines, by the traveling condition data generation unit 322, that the unmanned vehicle 2 does not pass through the vicinity of the manned vehicle (No in step ST12), the processing ends.

If it is determined that the unmanned vehicle 2 passes through the vicinity of the manned vehicle (Yes in step ST12), the arithmetic processing device 32 determines, by the traveling condition data generation unit 322, whether a predetermined condition in which the safety level decreases is satisfied (step ST13). More specifically, the arithmetic processing device 32 determines, by the traveling condition data generation unit 322, whether or not the safety level is lowered depending on whether or not at least one of a condition related to the manned vehicle, a condition related to a place, a condition related to the environment, or a condition related to another unmanned vehicle 2 is satisfied as the predetermined condition. If the arithmetic processing device 32 determines, by the traveling condition data generation unit 322, that the safety level is lowered (Yes in step ST13), the processing proceeds to step ST14. If the arithmetic processing device 32 does not determine, by the traveling condition data generation unit 322, that the safety level is lowered (No in step ST13), the processing ends.

If it is determined that the safety level is lowered (Yes in step ST13), the speed limit of the unmanned vehicle 2 is changed (step ST14). More specifically, the arithmetic processing device 32 lowers the speed limit of the unmanned vehicle 2 by the traveling condition data generation unit 322.

The arithmetic processing device 32 outputs traveling condition data in which the speed limit is reduced by the traveling condition data generation unit 322 to the control device 10 of the unmanned vehicle 20 via the input and output interface 31 (step ST15).

In the unmanned vehicle 2, a control signal is output to the traveling device 23 so as to reduce the speed limit of the unmanned vehicle 2 on the basis of the traveling condition data acquired from the management device 3 via the input and output interface 11.

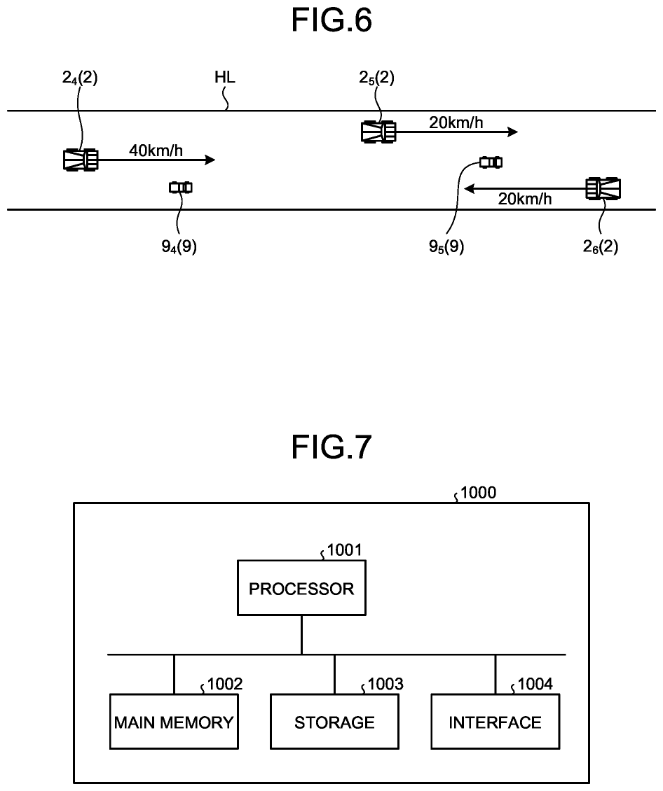

A control method of the speed limit of the unmanned vehicle 2 will be described in detail with reference to FIGS. 5 and 6. FIG. 5 is a schematic diagram illustrating an example of the speed limit of unmanned vehicles 2. FIG. 6 is a schematic diagram illustrating another example of the speed limit of unmanned vehicles 2. Let us presume that at a work site, a normal speed limit of the unmanned vehicles 2 is 50 [km/h]. As illustrated in FIG. 5, for example, an unmanned vehicle 2₁ passes through a side of a manned vehicle 9₁ in a travel path HL. The speed limit of the unmanned vehicle 2₁ is reduced to 40 [km/h] and travels on a side of the manned vehicle 9₁ at a traveling speed of 40 [km/h]. For example, an unmanned vehicle 2₂ passes through a side of a manned vehicle 9₂ at an intersection. The speed limit of the unmanned vehicle 2₂ is reduced to 30 [km/h] and travels on the side of the manned vehicle 9₂ at a traveling speed of 30 [km/h]. For example, an unmanned vehicle 2₃ passes through a side of a manned vehicle 9₃ at a place where there is an obstacle ahead in the traveling direction and it is difficult to estimate the traveling direction. The speed limit of the unmanned vehicle 2₃ is reduced to 20 [km/h] and travels on the side of the manned vehicle 9₃ at a traveling speed of 20 [km/h].

As illustrated in FIG. 6, for example in a travel path HL, an unmanned vehicle 2₄ passes through a side of a manned vehicle 9₄. There are no other vehicles around the unmanned vehicle 2₄ or the manned vehicle 9₄. The speed limit of the unmanned vehicle 2₄ is reduced to 40 [km/h] and travels on the side of the manned vehicle 9₄ at a traveling speed of 40 [km/h]. For example, unmanned vehicles 2₅ and 2₆ pass through the sides of a manned vehicle 9₅. The speed limits of the unmanned vehicles 2₅ and 2₆ are reduced to 20 [km/h] and travel on a side of the manned vehicle 9₅ at a traveling speed of 20 [km/h].

### Computer System

FIG. 7 is a block diagram illustrating an example of a computer system 1000. Each of the management device 3 and the control device 10 described above includes the computer system 1000. The computer system 1000 includes a processor 1001 such as a CPU, a main memory 1002 including a nonvolatile memory such as a ROM and a volatile memory such as a RAM, a storage 1003, and an interface 1004 including an input and output circuit. The functions of the management device 3 and the functions of the control device 10 are stored in the storage 1003 as a program. The processor 1001 reads the program from the storage 1003, loads the program in the main memory 1002, and executes the above-described processing in accordance with the program. Note that the program may be distributed to the computer system 1000 via a network.

### Effects

As described above, in the present embodiment, the speed limit of the traveling speed of the unmanned vehicle 2 is changed on the basis of the information indicating the safety level when the unmanned vehicle 2 travels on a side of a manned vehicle. In the present embodiment, the speed limit of the unmanned vehicle 2 can be reduced only when necessary on the basis of the information indicating the safety level. According to the present embodiment, it is possible to secure the safety of a work site where the unmanned vehicle 2 operates and to suppress a decrease in the productivity.

In the present embodiment, in a case where the unmanned vehicle 2 passes by a side of a small vehicle or a manned vehicle with a poor field of view, the speed limit of the unmanned vehicle 2 is changed. A small vehicle or a manned vehicle is often smaller and lighter than the unmanned vehicle 2, and there is a risk that a significant damage will occur in a case of a collision with the unmanned vehicle. Therefore, in the present embodiment, in a case where the field of view of the manned vehicle is poor and it is difficult for the operator of the manned vehicle to visually recognize the unmanned vehicle 2, the safety of the manned vehicle can be maintained by reducing the speed limit of the unmanned vehicle 2.

In the present embodiment, in a case where the skill or the proficiency level of the operator of the manned vehicle is low, the speed limit of the unmanned vehicle 2 is changed. In the present embodiment, the safety of the manned vehicle can be maintained by reducing the speed limit of the unmanned vehicle 2 in a case where the skill or the proficiency level of the operator is low and recognition of the unmanned vehicle 2 is delayed or an avoidance operation is delayed. According to the present embodiment, safety can be maintained regardless of an operator of a manned vehicle.

In the present embodiment, in a case where the unmanned vehicle 2 is traveling at an intersection or in a work area, the speed limit of the unmanned vehicle 2 is changed. According to the present embodiment, in a case where it is difficult for the operator of the small manned vehicle to estimate the course of the unmanned vehicle 2, the safety of the manned vehicle can be maintained by reducing the speed limit of the unmanned vehicle 2.

In the present embodiment, in a case where an obstacle is present ahead in the traveling direction of the unmanned vehicle 2, the speed limit of the unmanned vehicle 2 is changed. According to the present embodiment, in a case where it is difficult for the operator of the small manned vehicle to estimate the course of the unmanned vehicle 2, the safety of the manned vehicle can be maintained by reducing the speed limit of the unmanned vehicle 2.

In the present embodiment, when the work site is at night or in rainy weather, the speed limit of the unmanned vehicle 2 is changed. In the present embodiment, it is possible to maintain the safety of a manned vehicle by reducing the speed limit of the unmanned vehicle 2 in a case of a poor field of view or in a case where there is a high risk of slipping. According to the present embodiment, it is possible to maintain the safety of the manned vehicle regardless of the period of time zone or the weather.

In the present embodiment, in a case where a plurality of unmanned vehicles 2 is located around a manned vehicle, the speed limit of the unmanned vehicle 2 is changed. The present embodiment can reduce the burden on the operator of the manned vehicle in a case where the number of objects to which the operator of the small manned vehicle pays attention increases. According to the present embodiment, the safety of the manned vehicle can be maintained.

### Other Embodiments

In the above-described embodiment, at least some of the functions of the control device 10 may be included in the management device 3, and at least some of the functions of the management device 3 may be included in the control device 10. For example, in the above-described embodiment, the control device 10 of the unmanned vehicle 2 may have the function of the traveling condition data generation unit 322 of the management device 3. The travel control unit 124 of the control device 10 controls the traveling speed of the unmanned vehicle 2 on the basis of a speed limit that has been calculated.

The unmanned vehicle 2 may include an obstacle sensor that detects an object around the unmanned vehicle 2 in a non-contact manner. An object detected by the obstacle sensor is, for example, an obstacle present on the travel path HL on which the unmanned vehicle 2 travels and another unmanned vehicle 2 traveling on the travel path HL.

### REFERENCE SIGNS LIST

1 CONTROL SYSTEM
2 UNMANNED VEHICLE
3 MANAGEMENT DEVICE
4 COMMUNICATION SYSTEM
6 WIRELESS COMMUNICATION DEVICE
7 LOADER
8 CRUSHER
10 CONTROL DEVICE
11 INPUT AND OUTPUT INTERFACE
12 ARITHMETIC PROCESSING DEVICE
121 TRAVELING CONDITION DATA ACQUISITION UNIT
122 POSITION DATA ACQUISITION UNIT
123 DETECTION DATA ACQUISITION UNIT
124 TRAVEL CONTROL UNIT
13 STORAGE DEVICE
21 VEHICLE BODY
22 DUMP BODY
23 TRAVELING DEVICE
23A DRIVE DEVICE
23B BRAKE DEVICE
23C STEERING DEVICE
27 WHEEL
27F FRONT WHEEL
27R REAR WHEEL
28 WIRELESS COMMUNICATION DEVICE
31 INPUT AND OUTPUT INTERFACE
32 ARITHMETIC PROCESSING DEVICE
321 OPERATION STATE DATA ACQUISITION UNIT
322 TRAVELING CONDITION DATA GENERATION UNIT
33 STORAGE DEVICE
35 INPUT DEVICE
36 OUTPUT DEVICE
41 POSITION SENSOR
42 STEERING ANGLE SENSOR
43 AZIMUTH ANGLE SENSOR
44 SPEED SENSOR
CS TRAVEL COURSE
HL TRAVEL PATH
IS INTERSECTION
PA WORK AREA
PI TARGET POINT

1. An unmanned vehicle control system comprising:
a traveling condition data generation unit that generates traveling condition data including a travel course of an unmanned vehicle and a traveling speed of the unmanned vehicle; and
a travel control unit that controls the unmanned vehicle on a basis of the traveling condition data generated by the traveling condition data generation unit,
wherein the traveling condition data generation unit changes a speed limit of the traveling speed of the unmanned vehicle on a basis of information indicating a safety level when the unmanned vehicle travels on a side of a manned vehicle.

2. The unmanned vehicle control system according to claim 1,
wherein the information indicating the safety level includes information indicating an attribute of the manned vehicle, and
the traveling condition data generation unit changes the speed limit of the unmanned vehicle on a basis of the attribute of the manned vehicle.

3. The unmanned vehicle control system according to claim 1,
wherein the information indicating the safety level includes information indicating an attribute of an operator of the manned vehicle, and
the traveling condition data generation unit changes the speed limit of the unmanned vehicle on a basis of the attribute of the operator of the manned vehicle.

4. The unmanned vehicle control system according to claim 1,
wherein the traveling condition data generation unit changes the speed limit of the unmanned vehicle on a basis of a difficulty level of estimation of a course of the unmanned vehicle.

5. The unmanned vehicle control system according to claim 4,
wherein the information indicating the safety level includes information indicating a place such as an intersection or a work area located ahead in a traveling direction of the unmanned vehicle, and
the traveling condition data generation unit changes the speed limit of the unmanned vehicle in a case where the unmanned vehicle is traveling at the intersection or in the work area as a case where it is difficult to estimate the course of the unmanned vehicle.

6. The unmanned vehicle control system according to claim 4,
wherein the information indicating the safety level includes information indicating an obstacle located ahead in a traveling direction of the unmanned vehicle, and
the traveling condition data generation unit changes the speed limit of the unmanned vehicle in a case where there is the obstacle located ahead in the traveling direction of the unmanned vehicle as a case where it is difficult to estimate the course of the unmanned vehicle.

7. The unmanned vehicle control system according to claim 1,
wherein the information indicating the safety level includes information indicating an environment of a work site, and
the traveling condition data generation unit changes the speed limit of the unmanned vehicle on a basis of the environment of the work site.

8. The unmanned vehicle control system according to claim 1,
wherein the information indicating the safety level includes information indicating whether there is another unmanned vehicle located around the unmanned vehicle, and
the traveling condition data generation unit changes the speed limit of the unmanned vehicle in a case where a plurality of unmanned vehicles is located around the manned vehicle.

9. An unmanned vehicle comprising the unmanned vehicle control system according to claim 1.

10. An unmanned vehicle control method comprising:
generating traveling condition data including a travel course of an unmanned vehicle and a traveling speed of the unmanned vehicle; and
controlling the unmanned vehicle on a basis of the traveling condition data that has been generated,
wherein a speed limit of the traveling speed of the unmanned vehicle is changed on a basis of information indicating a safety level when the unmanned vehicle travels on a side of a manned vehicle.
